(19) United States
(12) Patent Application Publication
(10) Pub. No.: US 2016/0236600 A1
(43) Pub. Date: Aug. 18, 2016

(54) VEHICLE SEAT WITH STRUCTURAL COVER FOR SEAT BACK FRAME

(71) Applicant: JOHNSON CONTROLS TECHNOLGY COMPANY, Holland, MI (US)

(72) Inventors: Carlo G. CITRON, Belle River (CA); Tony A. Zambon, Canton, MI (US)

(73) Assignee: Johnson Controls Technology Company, Holland, MI (US)

(21) Appl. No.: 15/028,187

(22) PCT Filed: Oct. 17, 2014
(86) PCT No.: PCT/US2014/061108

§ 371 Date: Apr. 8, 2016

Related U.S. Application Data
(60) Provisional application No. 61/892,969, filed on Oct. 18, 2013.

(51) Int. Cl. B60N 2/58; B60N 2/68

(52) U.S. Cl. CPC B60N 2/5825; B60N 2/686

(57) ABSTRACT

A vehicle seat may include a seat back frame with a rear surface and a structural cover configured to attach to the seat back frame. The structural cover may have an opening in a center portion of the structural cover and may cover at least a portion of the rear surface of the seat back frame. The structural cover and the portion of the rear surface of the seat back frame may not be covered by any foam.

### CROSS-REFERENCE TO RELATED PATENT APPLICATIONS

This application claims priority to and the benefit of U.S. Provisional Patent Application No. 61/892,969, filed Oct. 18, 2013, the entire disclosure of which is incorporated herein by reference.

### FIELD

The present application relates generally to a vehicle seat with a structural cover for use in a seat back within moveable devices.

### BACKGROUND

Typically, the interior space within vehicles is limited due design constraints and vehicle size constraints. More specifically, there may be limited space for knee or leg clearance between the front row seats and the second row seats.

The space between the front row seats and the second row seats can be constrained by the thickness or depth of the seat back of the front row seat. A typical vehicle seat 12 with a seat back 14 is shown in FIG. 11. Currently, many seat backs include a hard, plastic substrate or back panel 30 in the center of the backside of the seat back 14, surrounded by foam and trim. The back panel 30 is typically a rigid piece of plastic that must substantially rest on the outside of the seat back 14. Due to the design of the back panel 30, a trim/foam combination 18 must wrap around the sides of the seat back 14 to the back of the seat 12 in order to create the proper contours. Accordingly, the trim/foam combination 18 thickens the seat structure and reduces the amount of potential knee clearance. However, without the foam on the seat back 14, the seat 12 may not be contoured properly or have adequate craftsmanship.

Further, a map pocket 16 may be located on the back panel 30 and may stick out from the back panel 30, away from the seat frame. Accordingly, the map pocket 16 may add to the thickness of the seat back 14 and may further reduce the potential leg room for the occupant behind the vehicle seat.

The back panel 30, the trim/foam combination 18, and the map pocket 16 all add to the thickness of the seat back 14 and decrease the potential leg and knee clearance behind the seat 12.

### SUMMARY

According to one embodiment, a vehicle seat may include a seat back frame with a rear surface and a structural cover configured to attach to the seat back frame. The structural cover may have an opening in a center portion of the structural cover and may cover at least a portion of the rear surface of the seat back frame. The structural cover and the portion of the rear surface of the seat back frame may not be covered by any foam.

According to another embodiment, a method of attaching a structural cover to a seat back frame may include hooking at least one hook around one of a top portion and a bottom portion of the seat back frame, angling the structural cover to be substantially parallel to a rear surface of the seat back frame, and snapping at least one snap of the structural cover to the other of the top portion and the bottom portion of the seat back frame. The hook may extend from the structural cover. The structural cover may include an opening along a center portion of the structural cover.

### BRIEF DESCRIPTION OF THE DRAWINGS

FIG. 1 is a perspective view of a vehicle according to one embodiment.

FIG. 2 is a perspective front view of a vehicle seat that may be disposed in the vehicle of FIG. 1.

FIG. 3 is a perspective back view of a vehicle seat with a structural cover that may be disposed in the vehicle of FIG. 1 according to one embodiment.

FIG. 4A is a perspective back view of a vehicle seat with a structural cover according to one embodiment.

FIG. 4B is a side view of a vehicle seat with a structural cover that may be disposed within the vehicle seat of FIG. 2.

FIG. 5A is a front view of a structural cover attached to a seat back frame that may be disposed within the vehicle seat of FIG. 2.

FIG. 5B is a back view of the structural cover of FIG. 5A.

FIG. 6 is a side view of a structural cover and a back panel with a seat back frame.

FIG. 7A is a cross-sectional, top view of a structural cover and a back panel with a seat back frame.

FIG. 7B is a cross-sectional, top view of a structural cover and a back panel with a seat back frame with seat back pockets attached.

FIG. 8 is a perspective view of a structural cover that may be disposed within the vehicle seat of FIG. 2.

FIG. 9A is a perspective view of a structural cover that may be disposed within the vehicle seat of FIG. 2.

FIG. 9B is a front view of the structural cover of FIG. 9A.

FIGS. 9C-9H are side and cross-sectional view of the structural cover of FIGS. 9A-9B.

FIGS. 10A-10E are views of a structural cover being attached to a seat back frame of a vehicle seat.

FIG. 11 is a perspective back view of a vehicle seat with a back panel that may be disposed in the vehicle of FIG. 1.

### DETAILED DESCRIPTION

Referring generally to the figures, disclosed herein is a vehicle seat with a seat back frame and a structural cover, as shown according to exemplary embodiments. The structural cover may attach to a seat back frame within a seat back of a vehicle seat to reduce or minimize the thickness or depth of the seat back. The structural cover may minimize the depth of the seat back to maximize the space behind the seat and between the rows of seats (e.g. rear seat occupant leg room or knee clearance). The structural cover may add to, improve, or maintain the desired style of the vehicle interior, as well as improve the safety of the vehicle seat. The structural cover may be used within any vehicle seat that has additional seating located behind the vehicle seat, such as on the back of the front row seats or the second or third row seats.

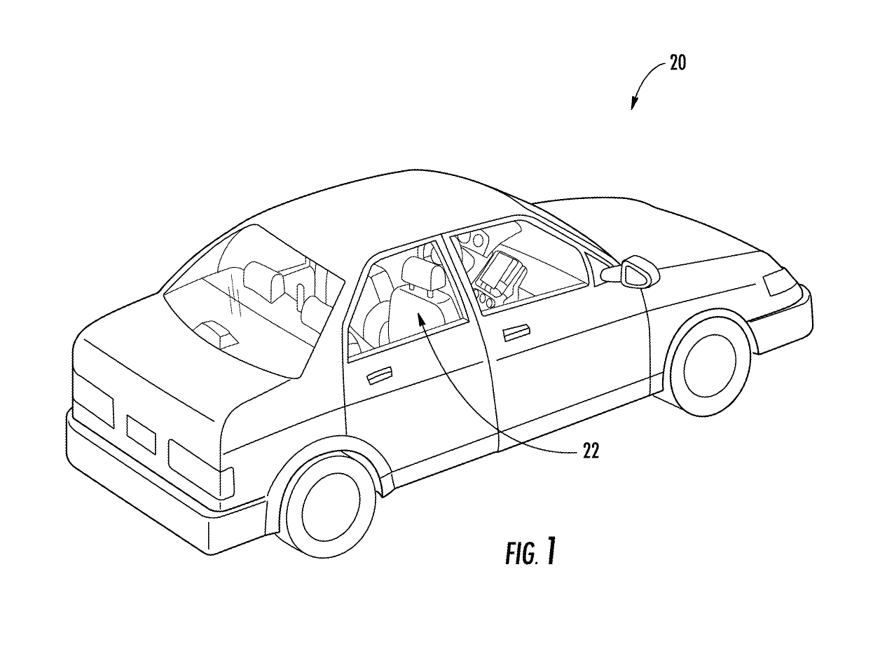

FIG. 1 illustrates an exemplary embodiment of a vehicle 20 that may include a vehicle seat 22 with a structural cover. The vehicle 20 may include an interior passenger compartment containing the vehicle seat 22 for providing seating to an occupant. Although a four door sedan automobile is shown in FIG. 1, the vehicle seat 22 may be used in a variety of applications, but is particularly useful within a vehicle seat in any type of vehicle, such as a two door or four door automobile, a truck, a SUV, a van, a train, a boat, an airplane, or other suitable vehicular conveyance.

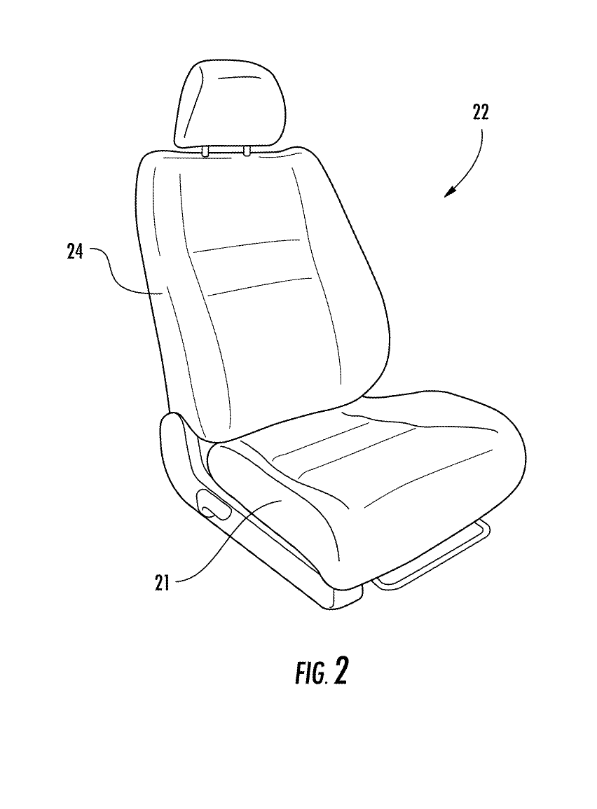

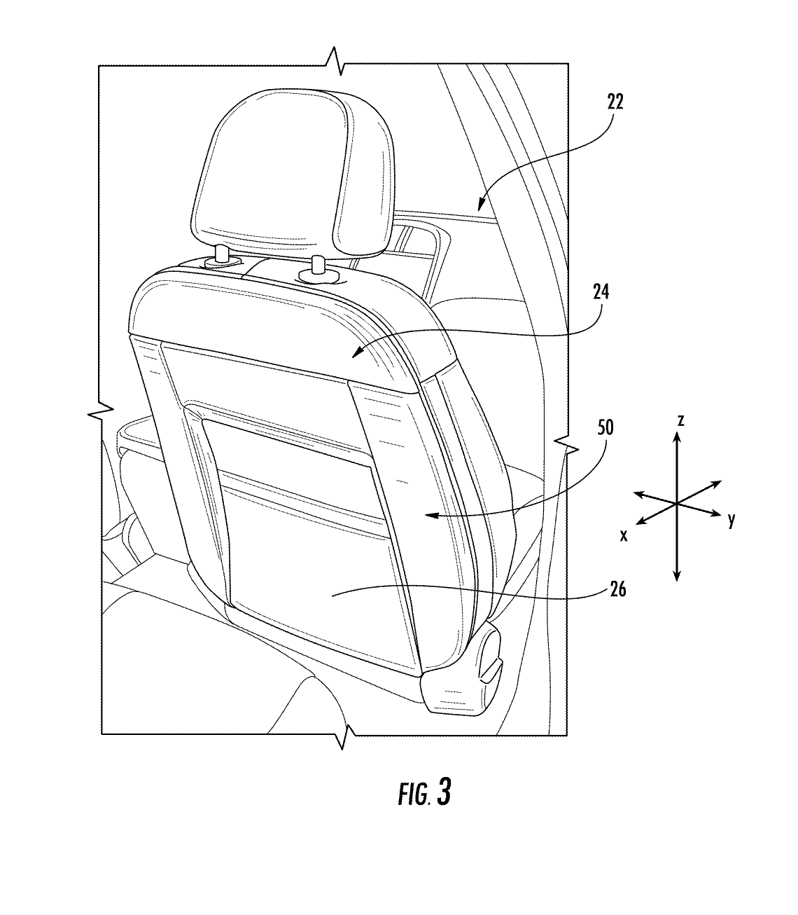

According to one embodiment as depicted in FIG. 2, the vehicle seat 22 may include a seat back 24 and a seat cushion 21. As shown in FIG. 3, the seat back 24 of the vehicle seat 22 may include various components, such as a seat back frame 25 and a structural cover 50 (as shown further in subsequent figures). The seat cushion 21 may include a seat cushion frame (not shown). The seat back frame 25 may include a rear surface 27, a front surface 29, and side surfaces. The side surfaces may be substantially perpendicular to the rear surface 27 and the front surface 29 and may face the sides of the vehicle 20. The rear surface 27 and the front surface 29 may be substantially parallel and may face the back and the front, respectively, of the vehicle 20.

The structural cover 50 may be particularly useful for reducing the depth of the vehicle seat 22. For example, the structural cover 50 may bring the rearmost surface of the seat back 24 inward toward the seat back frame to allow for more room within the vehicle 20 without sacrificing the comfort of the vehicle seat occupant. For example, as described further herein, the slim design and attachment of the structural cover 50 to the seat back frame 25, the reduction or elimination of the trim/foam combination on the back of the seat back 24, and the recessed map pocket 26 all contribute to the reduction of the seat back thickness and the increase in knee clearance and leg room behind the seat 22.

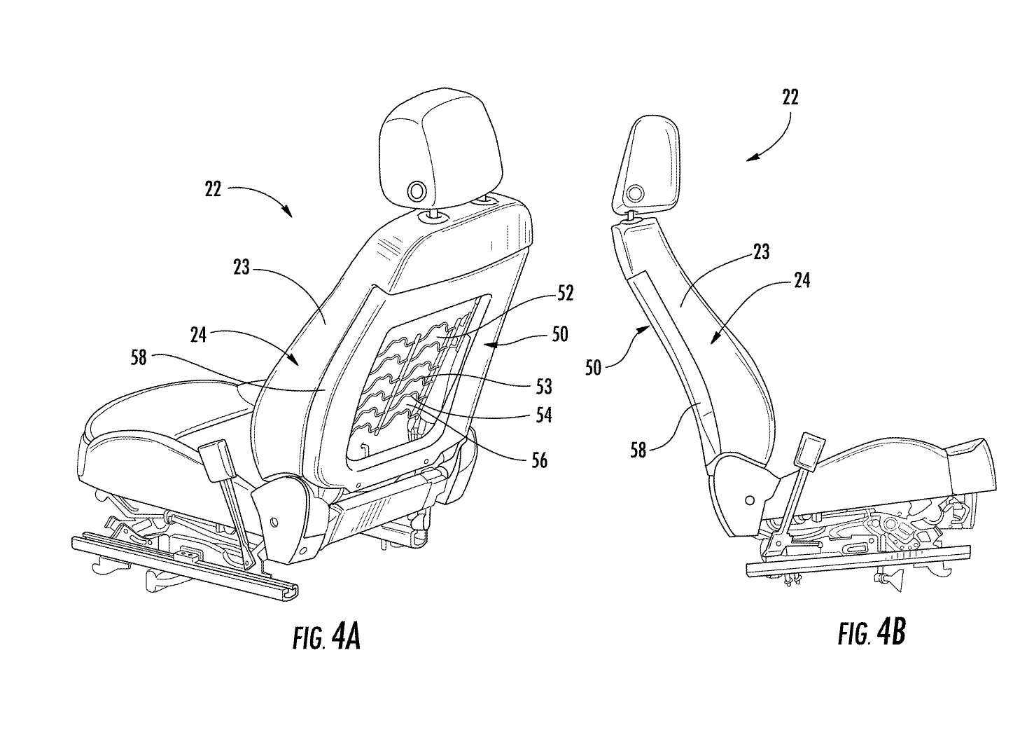

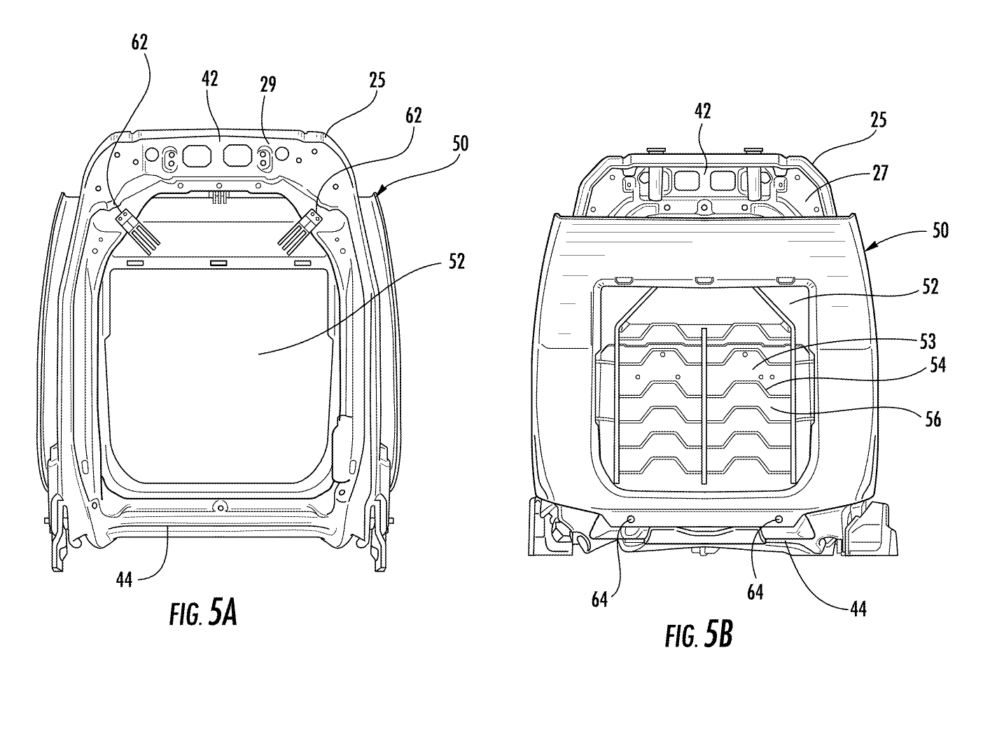

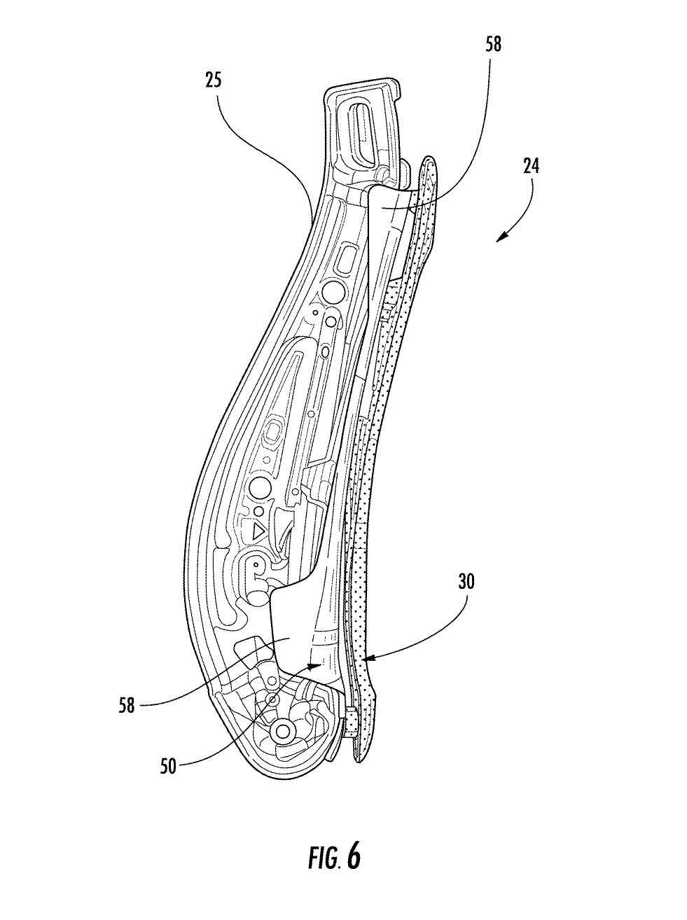

Referring now to FIGS. 4A-4B, there is shown the seat 22 with a trim ring, seat back panel, seat back plate, or structural cover 50 at least partially integrated into the seat back frame 25 of the seat back 24, thereby reducing or minimizing the thickness or depth of the seat back 24 and increasing the potential knee clearance behind the vehicle seat 22. As shown in FIGS. 5A-5B, the structural cover 50 may be attached directly or indirectly to the seat back frame 25 of the seat back 24 through a variety of different methods (as described further herein). Accordingly, the structural cover 50 may cover at least a portion of a rear surface 27 of the seat back frame 25, thus providing the desired contour and shape of the seat back 24. The structural cover 50 defines the rearmost surface of the vehicle seat 12 and can isolate the occupants from the seat back frame 25 by providing sufficient coverage and structural rigidity. Therefore, at least the structural cover 50 and the portion of the rear surface 27 of the seat back frame 25 (that is covered by the structural cover 50) are not covered by and do not require any foam, even when the seat 22 is fully assembled. By eliminating the foam, the structural cover 50 reduces the depth (e.g., along the x-axis, as shown in FIG. 3) of the seat back 24 and provides more room within the vehicle 20.

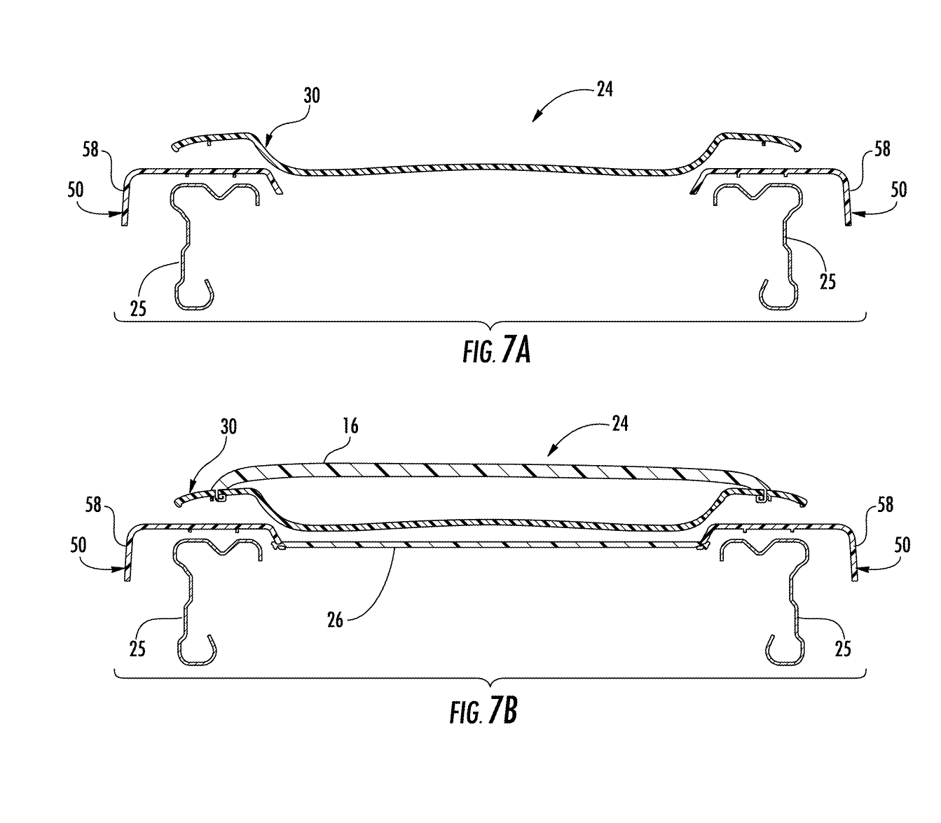

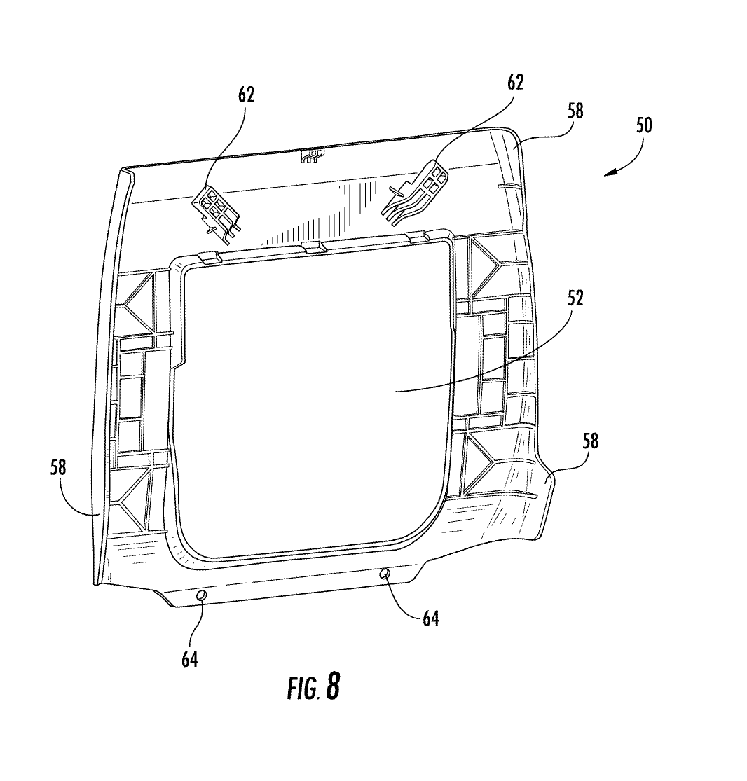

The contour, size, and shape of the structural cover 50 may allow the structural cover 50 to attach or be secured closer to and be more integrated with the seat back frame 25 than the traditional back panel 30 to minimize the thickness or depth of the seat back 24. FIGS. 6 and 7A-7B show the side of the seat back frame 25 with both the structural cover 50 and the back panel 30 attached for comparison. As shown, the structural cover 50 is able to rest closer to the seat back frame 25 than the back panel 30. Accordingly, a seat back frame with the traditional back panel 30 attached has a greater depth than the seat back frame 25 with the structural cover 50 attached. The structural cover 50 lies close and essentially parallel to the seat back frame 25, while the back panel 30 protrudes away from the seat back frame 25. Since the back panel 30 does not provide all of the desired contours of the seat back 24, the back panel 30 must protrude away from the seat back frame 25 in order to allow sufficient room for the foam. However, since the structural cover 50 provides the desired contours for the seat back 24 and thus replaces the foam, the structural cover 50 lies very close to the seat back frame 25, thus minimizing the thickness or depth of the seat back 24.

Further, since the structural cover 50 may span the entire width (e.g., along the y-axis, as shown in FIG. 3) of the seat back frame 25 (as shown in FIGS. 3, 4A, 5A-5B, and 7A-7B), the entire width of the seat back 24 may not include any foam along certain portions of the seat back 24. However, since the traditional back panel 30 does not does not wrap around the side of the seat back frame 25 or even span the entire width of the back of the seat back 24, the trim/foam combination 18 must wrap around to the back of the seat back 24, which adds to the thickness or depth of the seat back 24.

Eliminating the need for the trim/foam combination 18 along the back of the seat back 24 or behind the seat back frame 25 also allows for better craftsmanship, structure, shape, contour, and styling. For example, the contour, shape, size, and corners of the structural cover 50 may match, complement, or maintain a customer themed styling theme of the seat (STO), such as clean and crisp corners on the back of the seat back 24. The structural cover 50 may define the contour of the exposed back of the vehicle seat 22. For example, the exact shape of the back of the seat back 24 may be determined by the shape of the structural cover 50.

As shown in FIGS. 4A-4B, 6, 7A-7B, 9A, 9C, and 9D, the structural cover 50 may include side portions 58 that extend along or wrap around at least a portion of at least one side surface of the seat back frame 25. The side portions 58 may allow the structural cover 50 to provide sufficient support and the proper contours, as well as eliminate the need for the additional trim/foam combination 18 along the back (and sides) of the seat back 24. Further, by wrapping around at least some of the edges of the seat back frame 25, the structural cover 50 may provide a clean look (i.e. clean, crisp corners) within the vehicle 20. The side portions 58 may further interact with the side airbag (SIAB) in such a way to allow the SIAB to fully deploy when needed, while still allowing the structural cover 50 to closely attach to the seat back 24.

The side portions 58 may cover, wrap around, overlap, or scalp a portion of the sides of the seat back 24 to further secure the structural cover 50, to minimize the need for the foam 23, and to minimize the depth of the seat back 24, as shown, for example, in FIGS. 4A-4B. For example, due to the side portions 58, the foam 23 of the seat 22 therefore does not need to wrap around to the back of the seat back 24, thereby reducing the depth of the seat back 24. According to one embodiment, the edge of the foam 23 may extend to or meet with the edges of the structural cover 50. According to another embodiment, the foam may extend underneath the structural cover 50. Optionally, the structural cover 50 may cover portions of other sides of the seat back 24 and/or extend upwards or downwards to eliminate the need for foam 23 on the top or bottom of the seat back 24.

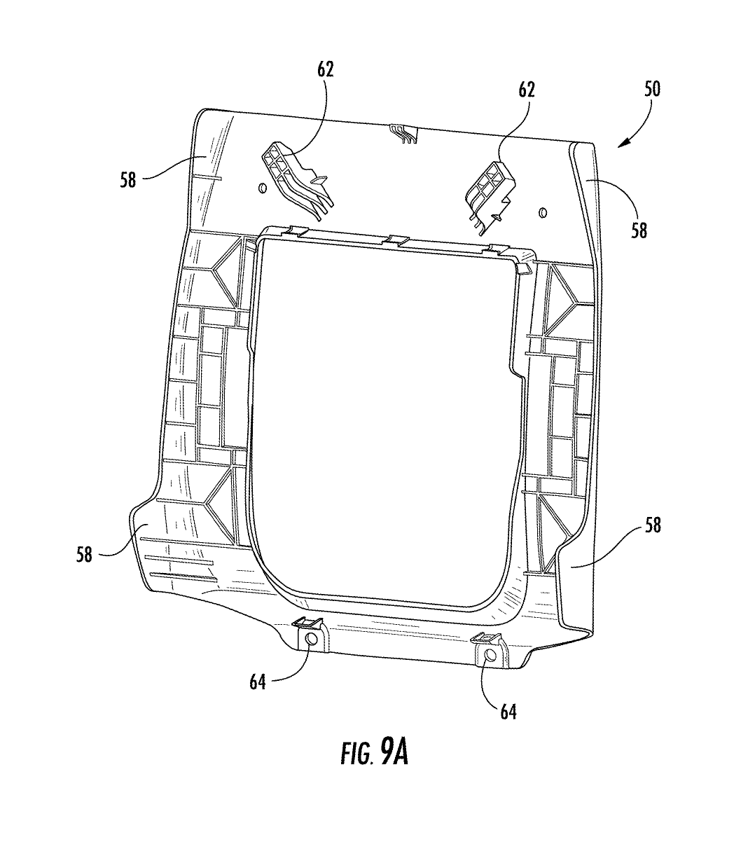

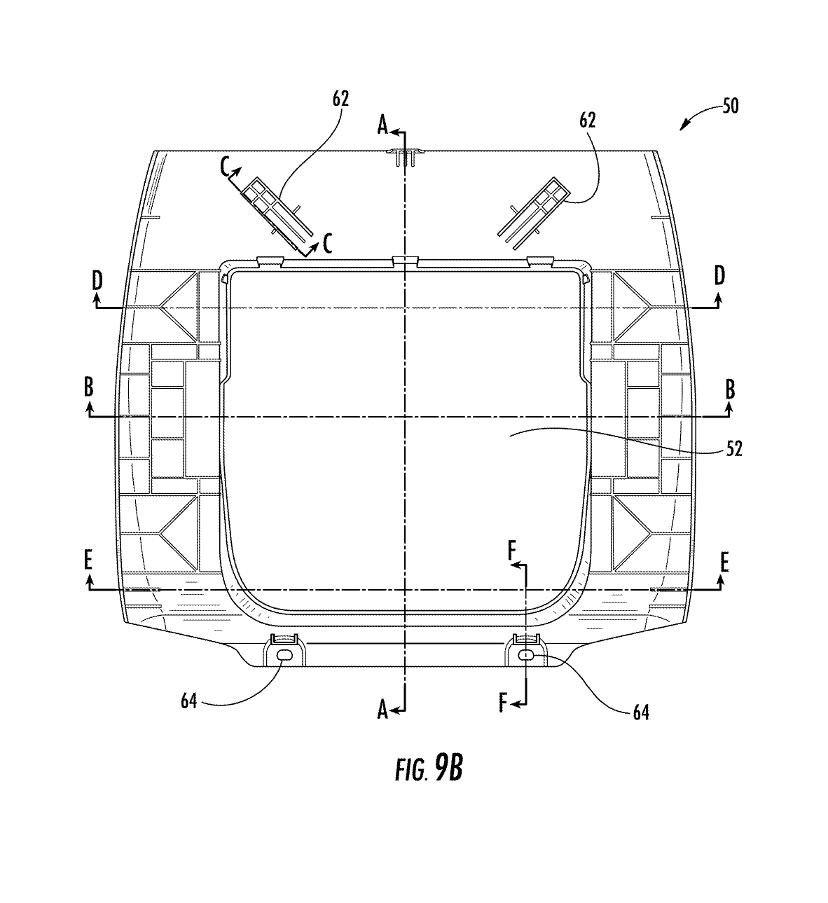

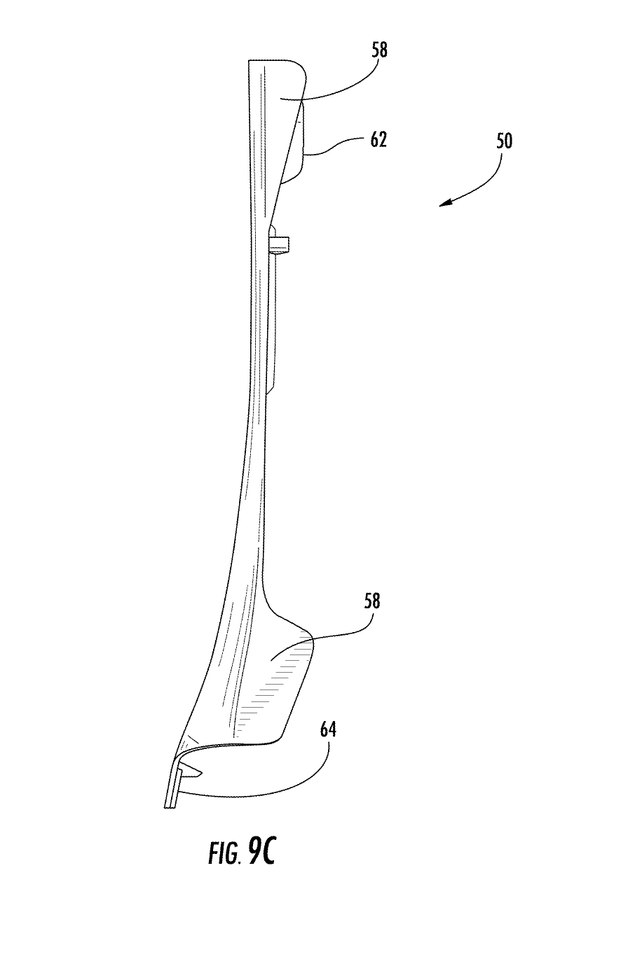

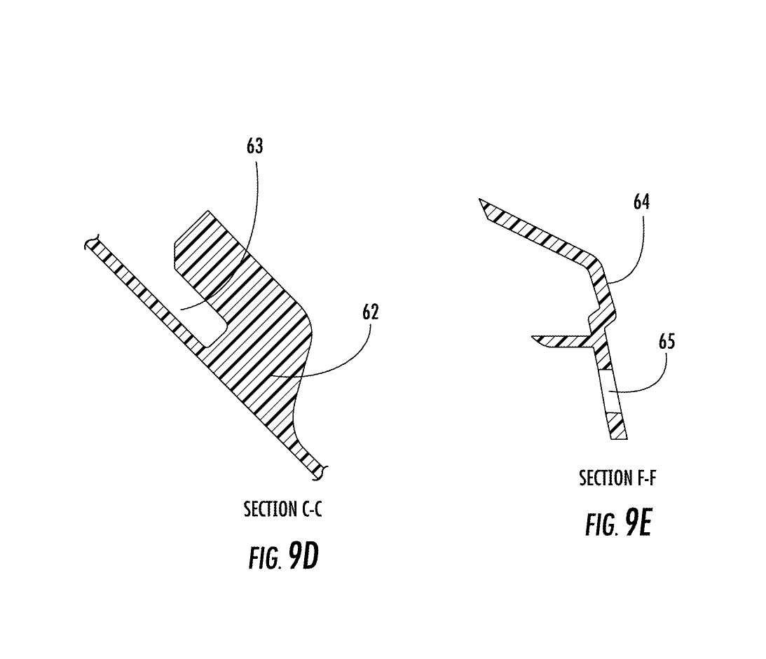

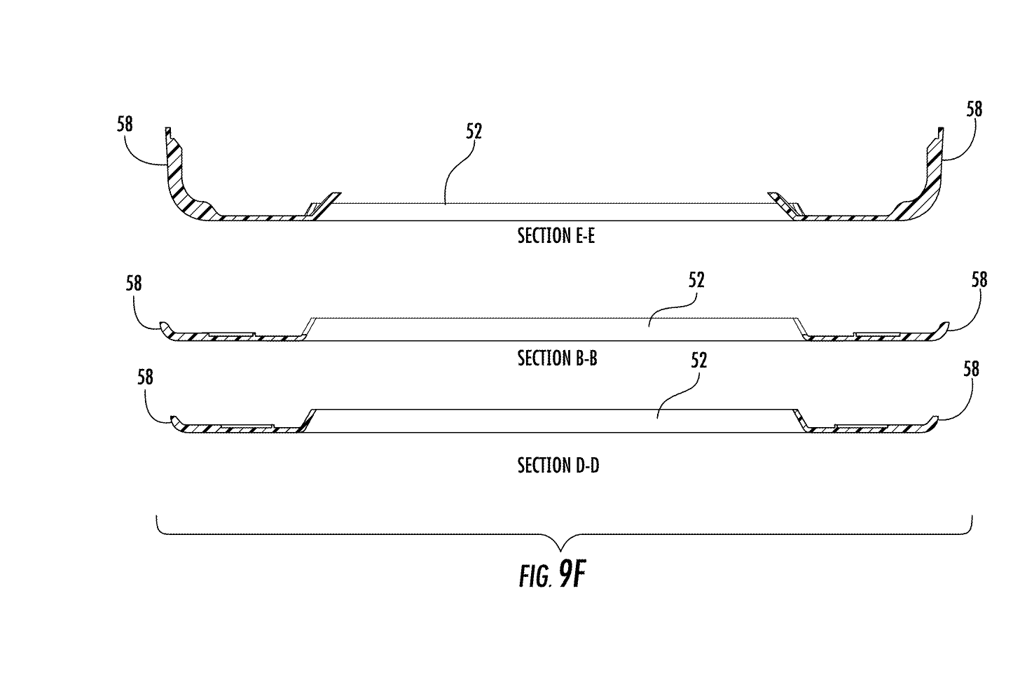

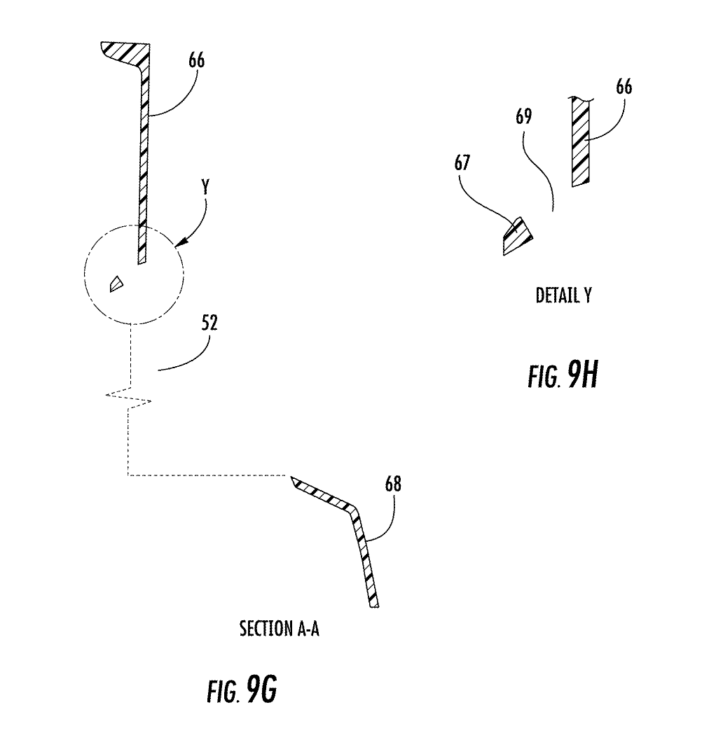

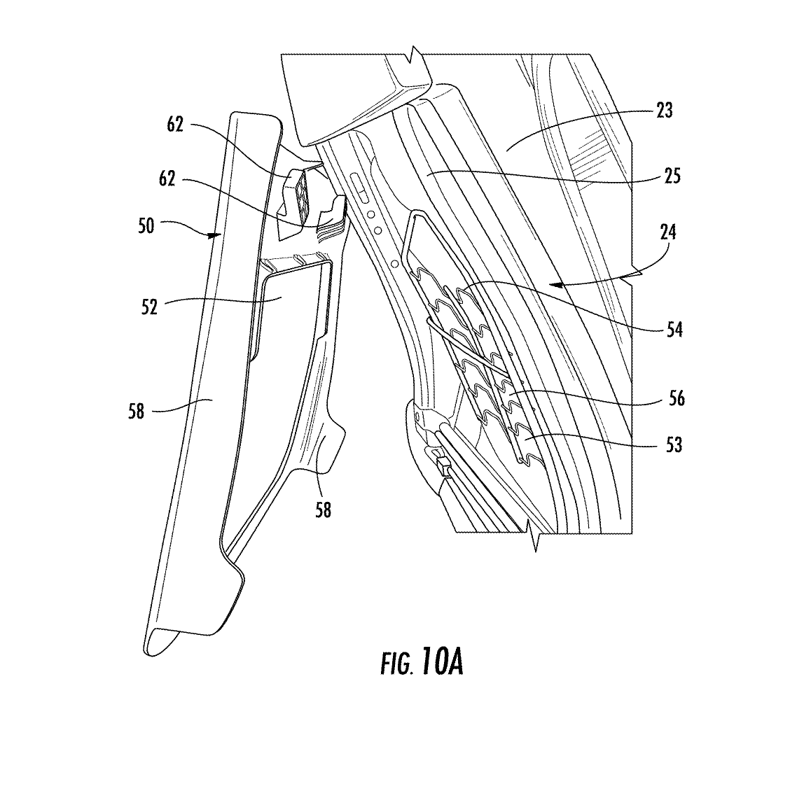

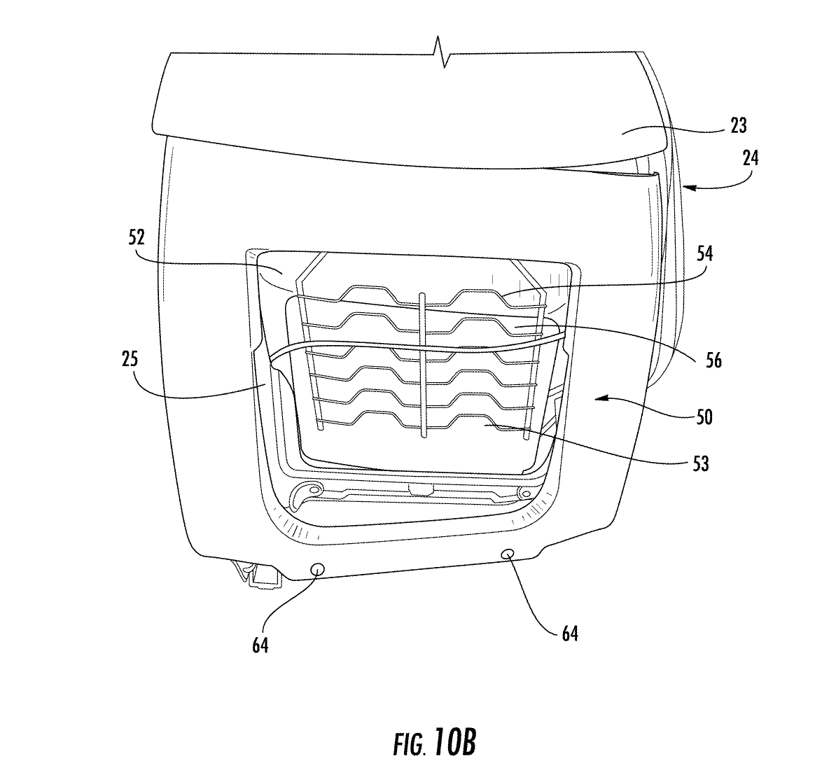

The side portions 58 may be designed in any configuration and may extend from a portion of the length (e.g., along the vertical direction or the z-axis, as shown in FIG. 3) of the structural cover 50 (as shown in FIGS. 4A-4B and on the right side of FIG. 8) or may extend from the entire length of the structural cover 50 (as shown in FIG. 9A and on the left side of FIG. 8). Further, the side portions 58 may extend along the entire depth of the side of the seat back 24 or along a portion of the depth of the seat back side. Accordingly, the side portions 58 may wrap around or extend along certain portions of the sides of the seat back 24, along the entire length and/or depth of the sides of the seat back 24, or none of the sides of the seat back 24 (i.e. the structural cover 50 may only cover the back portion of the seat back 24), depending on the desired configuration. FIG. 9D depicts cross-sectional, horizontal views of different areas along one embodiment of the structural cover 50. As shown between the different cross-sections, the side portions 58 may be different sizes (e.g., lengths) along the height of the structural cover 50 and therefore may have different amounts of overlap with the side of the seat back 24. According to another embodiment, the side portion 58 may have a consistent length along the height of the structural cover 50 (as shown, for example, in FIG. 4A).

The side portions 58 may wrap around or extend along all, some, or none of the seat back 24 edges or sides. However, it is anticipated that the structural cover 50 may only cover the back of the seat back 24 and may not wrap around the sides or edges of the seat back 24. Further, the side portions 58 may lie at a variety of distances from the side of the seat back frame 25 (as shown in FIGS. 7A-7B).

According to one embodiment as shown in FIGS. 8 and 9A-9B, the structural cover 50 may include an additional hole, cutout, or opening 52 in a center portion of the structural cover 50. Due to the flexibility of the structural cover 50 within the seat back 24 and the hole provided by the opening 52, the structural cover 50 may improve the safety of the vehicle by allowing an occupant in the vehicle seat 22 to move further into the seat 22 (e.g. in the event of a rear-end collision) compared to the rigid back panel 30. For example, the structural cover 50 may help contribute to achieving the safety requirements in federal safety requirement tests, such as the “FMVSS 202A Dynamic Testing”.

As shown in FIG. 5B, the opening 52 of the structural cover 50 may allow the center area of the structural cover 50 to be flexible and therefore may include a support or bladder system 53 to at least support the occupant. The bladder system 53 may be positioned at least within the opening 52 of the structural cover 50 and may be configured to extend along at least a portion of the opening 52. The bladder system 53 may be flexible within the opening 52 and may bend and flex within the opening 52 of the structural cover, thus supporting the occupant during use. Accordingly, the opening 52 of the structural cover 50, paired with bladder system 53, may help further absorb the impact of the collision, may allow the occupant to be further secured within the seat, and may increase the comfort and safety of the user.

The bladder system 53 may include springs, a mesh structure 54, a sheet 56 (which may be at least partially flexible), and/or additional seating content for the comfort and safety of the occupant. According to one embodiment, the mesh structure 54 may be any arrangement or mechanism (e.g., of springs, wires, or rods) to provide resistance to the force from the occupant. The sheet 56 may be a plastic sheet and designed to interact with the mesh structure 54 and/or provide support to the occupant. The mesh structure 54 and the sheet 56 may be used in combination with each other or separately.

As shown in FIG. 3, the opening 52 may also provide a space to integrate the map pocket 26 without increasing the overall depth of the seat back 24. Typically, with traditional back panels 30, the seat map pockets 16 protrude from the back panel 30, away from the seat back frame and into the knee and leg clearance area within the vehicle 20 (as shown, for example, in FIGS. 7B and 11). However, since the structural cover 50 may be integrated into the seat 22 and may include the opening 52, the map pocket 26 may be attached to and recessed within the opening 52 of the structural cover 50 to further minimize the depth of the seat back 24 while providing storage features, as further shown in FIG. 7B.

The structural cover 50 may attach to the seat back 24 through a variety of different mechanisms and may utilize existing attachments or attachment sites on the seat back frame 25, the seat back 24, or the seat 22. As shown in FIGS. 8 and 9A-9B, the structural cover 50 may have hooks 62 and clips or snaps 64 to attach to the seat back frame 25. The attachment mechanisms, such as the hooks 62 and the snaps 64, may be located anywhere along the structural cover 50. For example, the hooks 62 may extend from and be located towards the top of the structural cover 50 and may attach to the top portion or upper cross member 42 of seat back frame 25. The snaps 64 may be located towards the bottom of the structural cover 50 and may subsequently snap into the rear side of the bottom portion or lower cross member 44 of the seat back frame 25. Additional attachments or mechanisms, such as plastic fasteners, may be used to further secure the structural cover 50 to the seat back frame 25. As the structural cover 50 is fastened to seat back frame 25, it provides a complete compression against the seat back 24 to secure the components of the seat back 24 and to further decrease the depth of the seat back 24.

As shown in FIGS. 5A-5B, the structural cover 50 may attach to a variety of different portions of the seat back frame 25, such as the rear surface 27 and/or the front surface 29. For example, FIG. 5A depicts the front side of the seat back frame 25 (with respect to the vehicle 20). The hooks 62 of the structural cover 50 may be attached to the upper cross member 42 of the seat back frame 25. The hooks may at least partially surround an edge of the seat back frame 25 to help secure the structural cover 50 to the seat back frame 25. FIG. 5B depicts the back side of the seat back frame 25 (with respect to the vehicle 20). The snaps 64 of the structural cover 50 may attach into (or snap on) the lower cross member 44 of the seat back frame 25. However, it is anticipated that the hooks 62 may attach to the lower cross member 44 and the snaps 64 may attach to the upper cross member 42.

Although hooks and snaps are shown, it is anticipated that any type of temporary or permanent fastening device or method may be used to attach the structural cover 50 to the seat back frame 25. For example, screws, clips, double-stick tape, glue, epoxy, hook-and-loop fasteners, nails, sewing, adhesives, or welding may be used. Although a variety of fasteners may be used to attach the structural cover 50 to the seat back frame 25, they are not required. Instead, the structural cover 50 may employ a simple method of attaching to the seat back frame 25, as described previously.

FIGS. 9A-9H depict exemplary configurations of the structural cover 50. FIGS. 9A-9H may correspond with the structural cover 50 depicted in FIGS. 9A-9B. However, the structural cover 50 may be designed to attach with any seat back frame 25. The attachment mechanisms, such as the hooks 62 and the snaps 64, may be located anywhere along the structural cover 50. FIG. 9A depicts the attachments towards the top and towards the bottom of the structural cover 50.

FIG. 9B depicts a cross-section of a hook 62. The hook 62 may be located in one or more areas along the structural cover 50 and may attach onto an opposite side of the seat back frame 25. For example, a portion or edge of the seat back frame 25 may fit within crevice 63.

FIG. 9C depicts a cross-section of a snap 64. The snap 64 may be located in one or more areas along the structural cover 50 and may attach to the seat back frame 25 through a variety of mechanisms. For example, a portion of the seat back frame 25 may fit through hole 65. An additional fastener, such as a plastic attachment, may be added to secure the seat back frame 25 within the hole 65.

FIG. 9D depicts different side portions 58 along the height of the structural cover 50. The space between the side portions 58 denotes the opening 52 of the structural cover 50.

FIG. 9E depicts a cross-sectional, vertical view of the structural cover 50. The separation between the two portions of the structural cover 50 denotes the opening 52 of the structural cover 50 (the separation is shortened relative to the other figures for illustrative purposes). A top 66 is the top portion of the structural cover 50 and a bottom 68 is the bottom portion of the structural cover 50. The configuration between the top 66 and the bottom 68 may vary according to the shape and size of the structural cover 50 and the seat back frame 25. The top 66 and the bottom 68 may have lips to help attach to portions of the seat back frame 25, the seat back 24, or the foam 23.

FIG. 9F depicts a close-up view of a portion of the top 66 in FIG. 9E. An attachment site 67 may be used to attach to the seat back frame 25 or another portion of the seat back 24, such as the mesh structure 54 or the map pocket 26. The portion of the seat back 24 may fit through or attach to hole 69. There may be additional attachment sites through the structural cover 50 to secure items to the structural cover 50.

The structural cover 50 may be constructed out of any material depending on the desired pricing, weight, rigidity, flexibility, hardness, or softness. For example, the materials may include (but are not limited to) plastic, metal, composites, alloys, or polymers. Further, the structural cover 50 may be constructed through a variety of techniques, including 3D printing.

Further, according to one embodiment, an exposed portion of the structural cover 50 may be covered in trim to match or correspond with the styling of the rest of the vehicle 20. According to another embodiment, the exposed portion of the structural cover 50 may not require any trim to be attached. For example, the back surface of the structural cover 50 may exposed and the front surface of the structural cover 50 may face the rear surface 27 of the seat back frame 25 when the structural cover 50 is attached to the seat back frame 25. Accordingly, the back surface of the structural cover 50 may not require any trim due to the design and/or material of the structural cover 50.

The exact dimensions, configuration, and shape of the structural cover 50 (and various components, such as the opening 52) may be such that the depth of the seat back 24 is reduced (compared to using the back panel 30) and may be designed in or altered to any size, shape, or configuration in order to correspond and fit with any seat structure, seat back frame 25, or seat back 24 and according to the desired configuration and styling of the vehicle (i.e. to match the the desired STO). Optionally, the structural cover 50 may be flexible to allow the structural cover 50 to contour to or fit onto any shape of seat back 24.

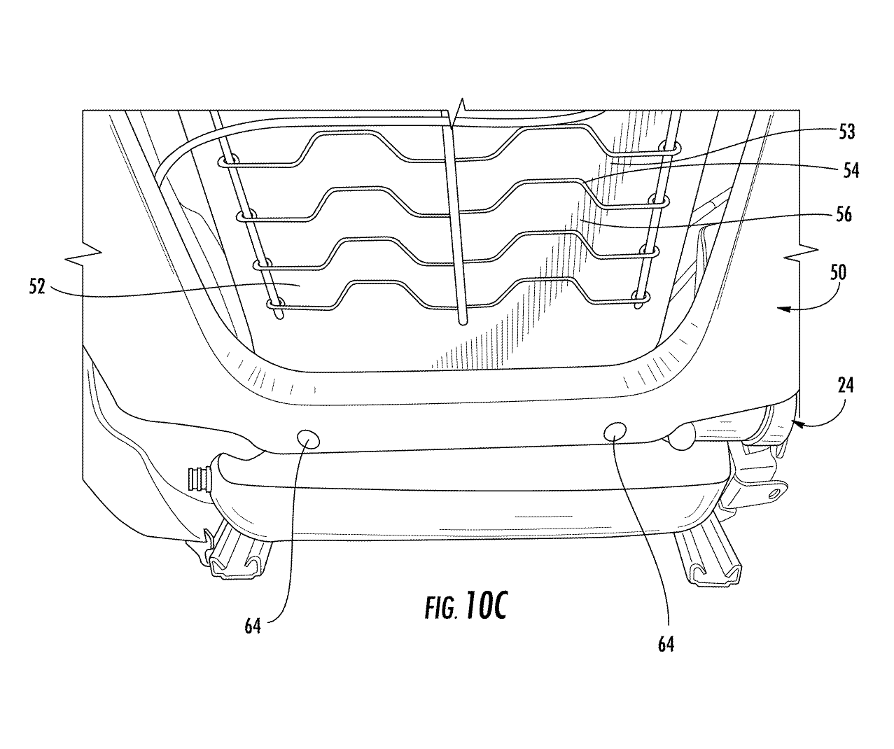

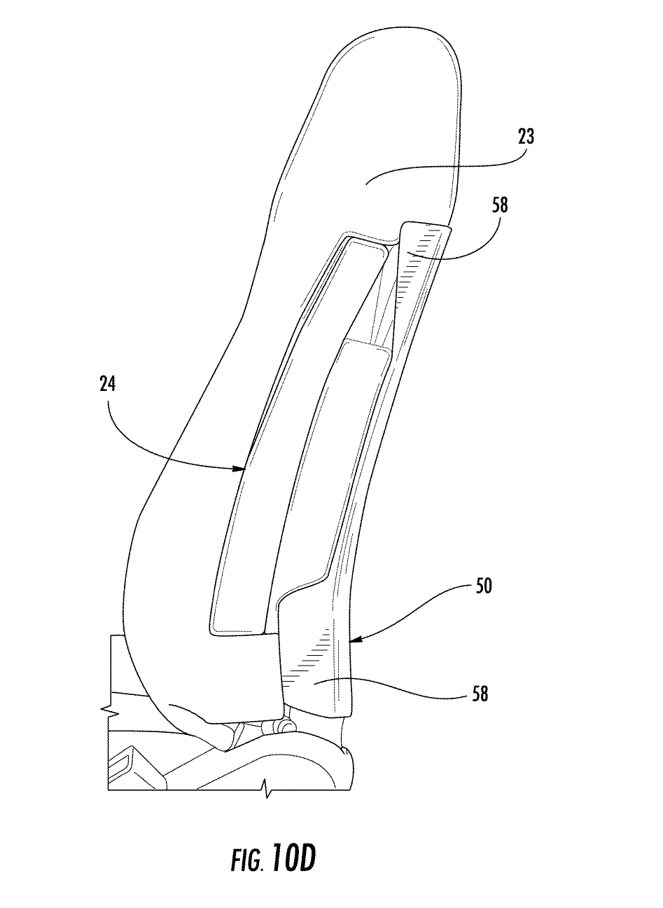

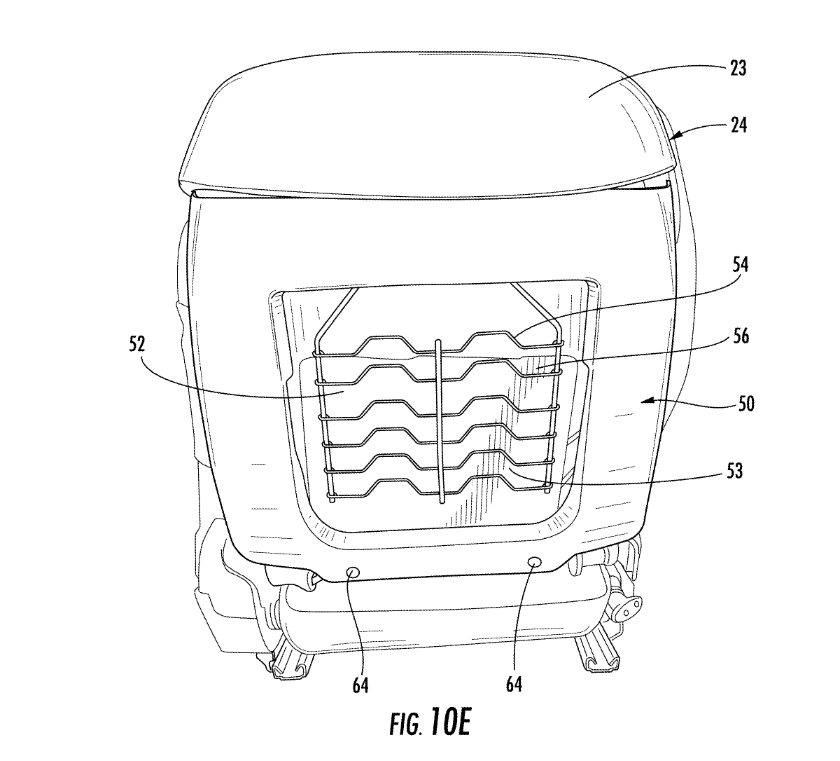

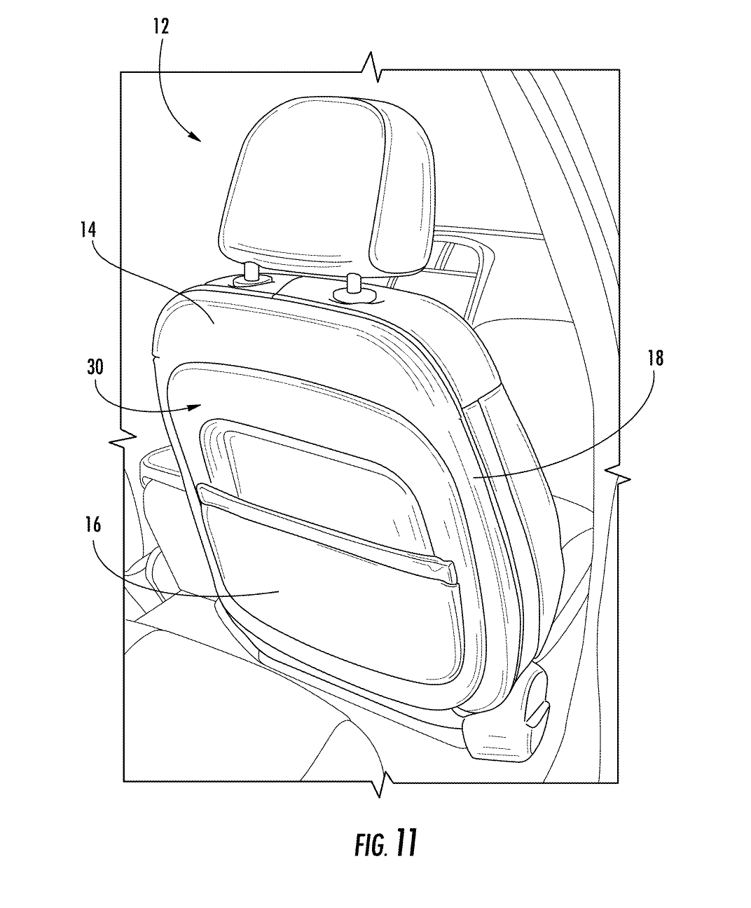

The structural cover 50 may be attached to the seat back frame 25 through a variety of different mechanisms and methods. FIGS. 10A-10E depict the assembly of the structural cover 50 to the seat back frame 25, according to one embodiment. First, as shown in FIG. 10A, the hooks 62 on the structural cover 50 are at least partially be secured to, attached to, or hook around the upper cross member 42 of the seat back frame 25 through existing attachment points or locations. An edge or hook of the seat back frame 25 may be secured within the hooks 62. Due to the configuration of the structural cover 50, the foam 23 is not required on the back of the seat 22. As shown in FIG. 10B, the structural cover 50 is drawn in or angled towards the seat back frame 25 in order to be substantially parallel to, or conform to, the rear surface 27 of the seat back frame 25. The bottom portion of the structural cover 50, with the snaps 64, is drawn in towards the bottom of the seat back frame 25 and the side portions 58 are drawn around the side of the seat back 24 (as shown in FIG. 10D) to allow the snaps 64 to snap to the lower cross member 44. FIG. 10C shows the snaps 64 attached to the lower cross member 44 of the seat back frame 25, fully securing the structural cover 50 along the seat back frame 25 and the seat back 24. FIG. 10D shows a side view of the structural cover 50 attached to the seat back frame 25. FIG. 10E shows the back view of the structural cover 50 attached to the seat back frame 25. It is anticipated that the snaps 64 could correspond and attach to the upper cross member 42 and the hooks 62 could correspond and attach to the lower cross member 44.

Additionally, the support or bladder system 53 may be attached to at least one of the seat back frame 25 or the structural cover 50 to allow the bladder system 53 to extend along the opening 52 of the structural cover 50 once the structural cover 50 is attached to the seat back frame 25. The bladder system 53 may be attached through a variety of different mechanisms and methods including, but not limited to, hooks, snaps, and clips.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

The embodiments disclosed herein reduce the thickness of a vehicle seat back while improving the safety of a vehicle seat and the overall design of the vehicle seat. Besides those embodiments depicted in the figures and described in the above description, other embodiments of the present invention are also contemplated. For example, any single feature of one embodiment of the present invention may be used in any other embodiment of the present invention.

Given the disclosure of the present invention, one versed in the art would appreciate that there may be other embodiments and modifications within the scope and spirit of the invention. Accordingly, all modifications attainable by one versed in the art from the present invention within the scope and spirit of the present invention are to be included as further embodiments of the present invention.

What is claimed is:

1. A vehicle seat comprising:
a seat back frame with a rear surface; and
a structural cover configured to attach to the seat back frame, wherein the structural cover has an opening in a center portion of the structural cover,
wherein the structural cover covers at least a portion of the rear surface of the seat back frame,
wherein the structural cover and the portion of the rear surface of the seat back frame are not covered by any foam.

2. The vehicle seat of claim 1, further comprising at least one of springs, a mesh structure, and a flexible sheet configured to extend along the opening.

3. The vehicle seat of claim 1, wherein the structural cover spans an entire width of the seat back frame.

4. The vehicle seat of claim 1, wherein the structural cover includes side portions that extend along at least one side surface of the seat back frame, wherein the rear surface and the side surface are substantially perpendicular.

5. The vehicle seat of claim 4, wherein the side portions extend from a portion of a length of the structural cover.

6. The vehicle seat of claim 4, wherein the side portions extend from an entire length of the structural cover.

7. The vehicle seat of claim 1, wherein structural cover defines a contour of an exposed back of the vehicle seat.

8. The vehicle seat of claim 1, wherein the structural cover includes at least one of hooks and snaps that are attachable to the seat back frame.

9. The vehicle seat of claim 8, wherein the seat back frame includes an upper cross member and a lower cross member, wherein the hooks are attachable to one of the upper cross member and the lower cross member of the seat back frame and the snaps are attachable to the other of the upper cross member and the lower cross member.

10. The vehicle seat of claim 1, further comprising a pocket attached to and recessed within the opening.

11. The vehicle seat of claim 1, further comprising trim, wherein the structural cover is positioned between the seat back frame and the trim.

12. The vehicle seat of claim 1, wherein trim is not attached along a back surface of the structural cover, wherein the front surface of the structural cover faces the rear surface of the seat back frame when the structural cover is attached to the seat back frame.

13. A method of attaching a structural cover to a seat back frame comprising:
hooking at least one hook around one of a top portion and a bottom portion of the seat back frame,
wherein the hook extends from the structural cover,
wherein the structural cover includes an opening along a center portion of the structural cover;
angling the structural cover to be substantially parallel to a rear surface of the seat back frame; and
snapping at least one snap of the structural cover to the other of the top portion and the bottom portion of the seat back frame.

14. The method of claim 13, further comprising attaching a support system to at least one of the seat back frame or the structural cover, wherein the support system extends along the opening when the structural cover is attached to the seat back frame, wherein the support system includes at least one of a spring, a mesh structure, and a flexible sheet.

15. The method of claim 13, wherein the structural cover includes at least one side portion that is configured to extend along at least one side surface of the seat back frame when the structural cover is attached to the seat back frame, wherein the rear surface and the side surface are substantially perpendicular.
